(19) United States
(12) Patent Application Publication
(10) Pub. No.: US 2007/0284224 A1
(43) Pub. Date: Dec. 13, 2007

(54) Device for rotating cup-shaped container in fitting plastic film

(76) Inventor: Benker P. C. Liao, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/450,312

(22) Filed: Jun. 12, 2006

(51) Int. Cl. B65G 37/00

(52) U.S. Cl. 198/620

(57) ABSTRACT

A device that rotates the cup-shaped container while the container is conveyed along a conveyer system to enhance properly fitting of a plastic film over the container is provided. The device includes an elongate chassis on which two parallel conveyer belts are movably supported for conveying the container in the longitudinal direction. At least a portion of each belt is inclined toward each other by arranging a transversely movable member under an outer edge of each belt whereby by selectively setting the transverse position of the member, the inclination of the belt is adjusted. Due to the inclination, the container that is positioned on the conveyer belts is in tangential engagement with the belts by an outer rim thereof. The belts are driven in different speeds, and this induces different linear speeds on the portions of the outer rim that engage the belts thereby causing rotation of the container about a center axis thereof. The rotation of the container enhances proper positioning of the plastic film loosely fitting over the container before the film is heated to shrink over the container.

### BACKGROUND OF THE INVENTION

1. Field of the Invention

The present invention generally relates to a device that rotates an article during the process of fitting a plastic film for purposes of protection and decoration over the article, and in particular to a device that employs two parallel conveyer belts inclined toward each other and moving in different speeds to rotate cup-shaped containers that are conveyed by the conveyer belts.

2. The Related Art

Heat-shrinkage films made of plastics are commonly used in packaging goods for purposes of decoration and protection. An example of the goods that is enclosed by the plastic film is heat-resistant cup-shaped containers that are often used to pack instant foods, such as instant noodles and brewing soups. Indications or decorations are often provided on the outer surface of the container by fitting a tubular plastic film on which the indications and decorations are printed over the container. However, due to the fact that the cup-like containers have a wide open top and a reduced bottom connected by a tapering outer surface and also owing to a gap existing between the plastic film and the container before the plastic film is heated to shrink over the outer surface of the container, it is often that the plastic film is not properly positioned over the outer surface of the container, which leads to flaw products in which for example the film is twisted, making indications and decorations entangling with each other and thus hard to read.

Manual inspection of the plastic film is conventionally used to ensure proper positioning of the plastic film on the container. However, this is a time- and labor-consuming job and is economically impractical. Further, it is impossible to automatize the manufacturing process for the cup-shaped containers. In addition, human error also increases the amount of unacceptable final products and the overall efficiency is reduced.

Thus, it is desired to have a device that overcomes the problems of incorrect fitting of plastic film over cup-shaped containers in a mass-production manufacturing line.

### SUMMARY OF THE INVENTION

To solve the problem of incorrect fitting of the plastic film over the cup-shaped container, in accordance with the present invention, a device that rotates the cup-shaped container while the container is conveyed along a conveyer system to enhance properly fitting of a plastic film over the container is provided. The device comprises an elongate chassis on which two parallel conveyer belts are movably supported for conveying the container in the longitudinal direction. At least a portion of each belt is inclined toward each other by arranging a transversely movable member under an outer edge of each belt whereby by selectively setting the transverse position of the member, the inclination of the belt is adjusted. Due to the inclination, the container that is positioned on the conveyer belts is in tangential engagement with the belts by an outer rim thereof. The belts are driven in different speeds, and this induces different linear speeds on the portions of the outer rim that engage the belts thereby causing rotation of the container about a center axis thereof. The rotation of the container enhances proper positioning of the plastic film loosely fitting over the container before the film is heated to shrink over the container.

The rotation of the container allows the plastic film that is loosely fit over the container to undergo displacement with respect to the container for correcting the position thereof. Thus, correctly positioning the plastic film over the container can be done automatically without manual interference. The manufacturing efficiency is enhanced and time and labor for manufacturing are reduced.

Further, the rotation of the container about the center axis thereof by the speed difference between the conveyer belts allows the plastic film to smoothly and effectively fit over the container. Thus, the plastic film is fit over the container in a consistent manner for all the containers in a mass production line.

In addition, the speed difference between the conveyer belts can be adjusted to accommodate cup-shaped containers of different specifications.

Also, the inclination of the belts can be adjusted to accommodate cup-shaped containers of different specifications.

### BRIEF DESCRIPTION OF THE DRAWINGS

The present invention will be apparent to those skilled in the art by reading the following description of a preferred embodiment thereof, with reference to the attached drawings, in which:

FIG. 1 is a top plan view of a device constructed in accordance with the present invention for rotating cup-shaped container to enhance fitting of plastic film over the container;

FIG. 2 is a perspective view, in an enlarged scale as compared to FIG. 1, of a portion of the device of the present invention, particularly showing an inclination adjusting device employed to selectively incline a conveyer belt at different angle;

FIG. 3 is a cross-sectional view taken along line A-A of FIG. 1, illustrating the formation of inclination of the belt;

FIG. 4 is a top plan view of a device constructed in accordance with another embodiment of the present invention for rotating cup-shaped container to enhance fitting of plastic film over the container;

FIG. 5 is a perspective view, in an enlarged scale as compared to FIG. 4, of a portion of the device of the present invention, particularly showing an inclination adjusting device employed to selectively incline a conveyer belt at different angle;

FIG. 6 is an exploded view of FIG. 5; and

FIG. 7 is a cross-sectional view taken along line B-B of FIG. 4, illustrating the formation of inclination of the belt.

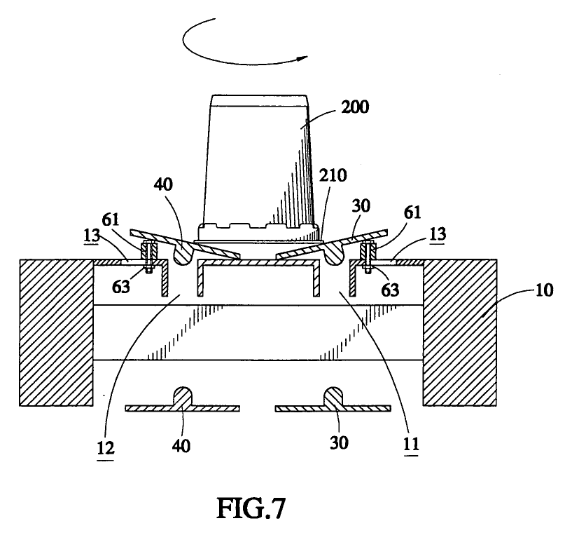

### DETAILED DESCRIPTION OF THE PREFERRED EMBODIMENT

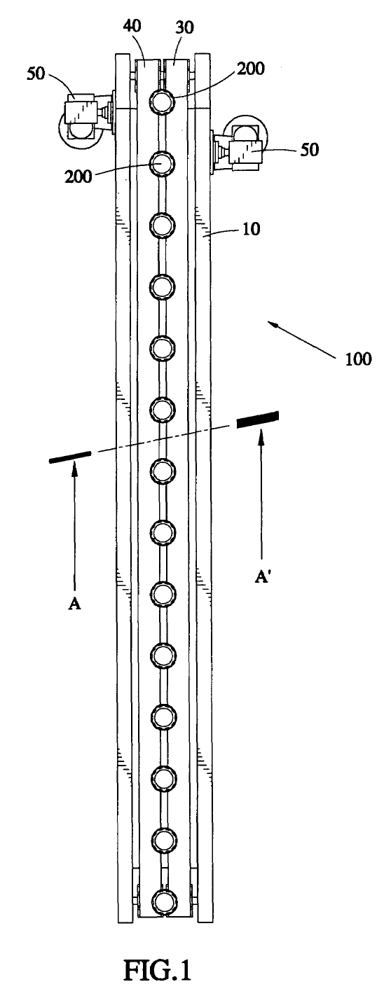

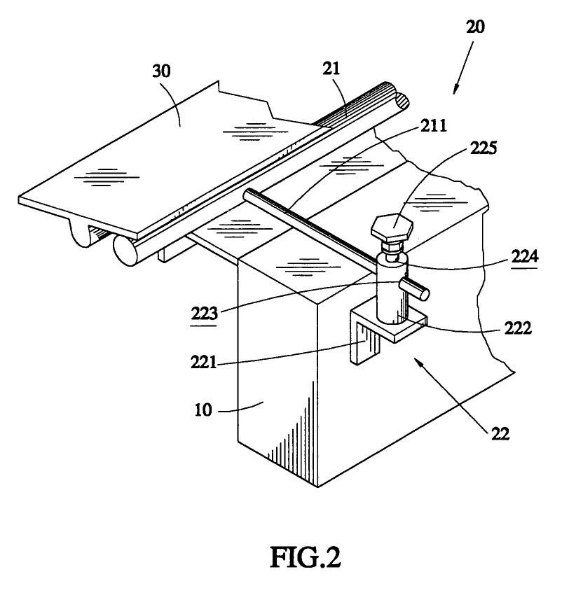

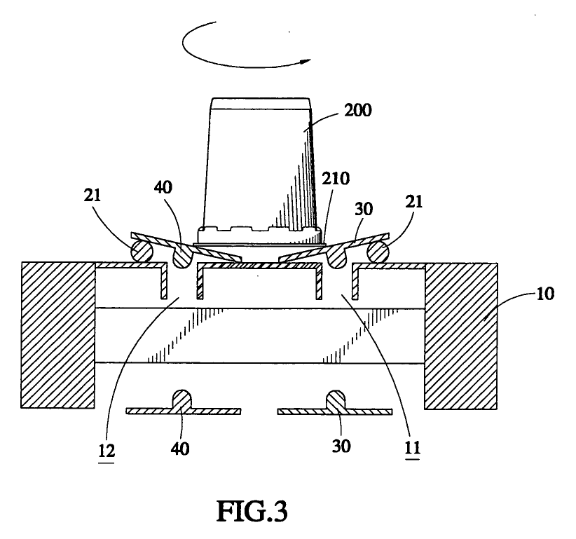

With reference to the drawings and in particular to FIGS. 1-3, a device that is constructed in accordance with a preferred embodiment of the present invention for rotating cup-shaped containers in fitting plastic film over the containers, which will be briefly referred to as “cup rotating device” hereinafter, is generally designated with reference numeral 100. The cup rotating device 100 comprises a chassis 10 that extends in a longitudinal direction and two conveyer belts 30, 40, substantially parallel to each other, supported on the chassis 10 and movable in the longitudinal direction for carrying and conveying a plurality of cup-shaped containers 200, and a driving system comprising at least one driving device 50 mechanically coupled to and selectively driving the conveyer belts 30, 40 in the longitudinal direction. In the embodiment illustrated, the driving system comprises two driving devices 50, respectively coupled to and driving each conveyer belt 30, 40.

Two conveyer slots 11, 12 are defined in a central portion of the chassis 10 to correspond to the conveyer belts 30, 40, respectively. An inclination adjusting device 20 is mounted to the chassis 10 adjacent to each conveyer slot 11, 12. The inclination adjusting device 20 comprises an elongate circular bar 21 extending in the longitudinal direction and functioning as a rail for engaging and guiding the associated conveyer belt 30, 40 to move thereon. The inclination adjusting device 20 comprises a plurality of adjustors 22 spaced along the chassis 10. Each adjustor 22 comprises a mount 221 fixed to a side face of the chassis 10 and a bar support 222 fixed on and supported by the mount 221. A through hole 223 extending in a transverse direction of the chassis is defined in the bar support 222. A coupling bar 211 has an inner end fixed to the rail 21 and an outer end extending through the hole 223 of the bar support 222 in a movable manner. By moving the coupling bar 211 with respect to the bar support 222, the location of the rail 21 with respect to the chassis 10 and thus the belt 30, 40 in the transverse direction is adjusted.

An inner-threaded hole 224 is defined in the bar support 222 and in communication with the through hole 223. A bolt 225 engages the inner-threaded hole 224 with a tip of the bolt 225 extending into the through hole 223 to engage and thus selectively fix the coupling bar 211 and thus the rail 21 in position with respect to the chassis 10 and the belt 30, 40.

The conveyer belt 30, 40 is partially received in the conveyer slot 11, 12 and is positioned on the rail 21 of the inclination adjusting device 20. The conveyer belt 30, 40 is made of a material capable of deformation of twisting whereby when an outer edge of the conveyer belt 30, 40 is lifted by the rail 21, the belt 30, 40 is twisted to have an opposite inner edge of the belt 30, 40 lowered down, making the belts 30, 40 inclined toward and facing each other. Thus, an inclination of the belt 30, 40 is effected by the rail 21 positioned under the outer edge of the belt 30, 40. By moving the rail 21 in the transverse direction, the inclination of the belt 30, 40 is changed and adjusted.

The conveyer belts 30, 40 are thus inclined toward each other and the cup-shaped container 200 is supported on the conveyer belts 30, 40 by a cup rim engaging both inclined belts 30, 40. In other words, the outer rim of the cup-shaped container 200 are substantially tangential to the conveyer belts 30, 40 The conveyer belts 30, 40 are driven by respective driving devices 50 to move in different speeds, which induces different linear speed of the portions of the cup-shaped containers 200 that engage the belts 30, 40, and thus causing rotation of the cup-shaped container 200 about a center axis thereof while the cup-shaped container 200 is moved forward by the belts 30, 40. The rotation of the cup-shaped container 200 about the center axis thereof causes relative displacement of a plastic film that is tubular and that is fit over the cup-shaped container 200 with respect to the cup-shaped container 200 and thus correcting relative position of the plastic film with respect to the container 200 and realizing snug and correct fitting of the plastic film around the cup-shaped container 200.

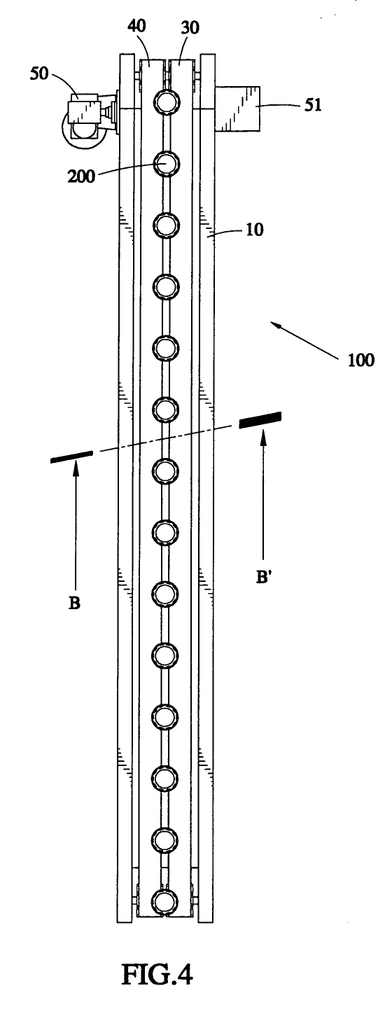

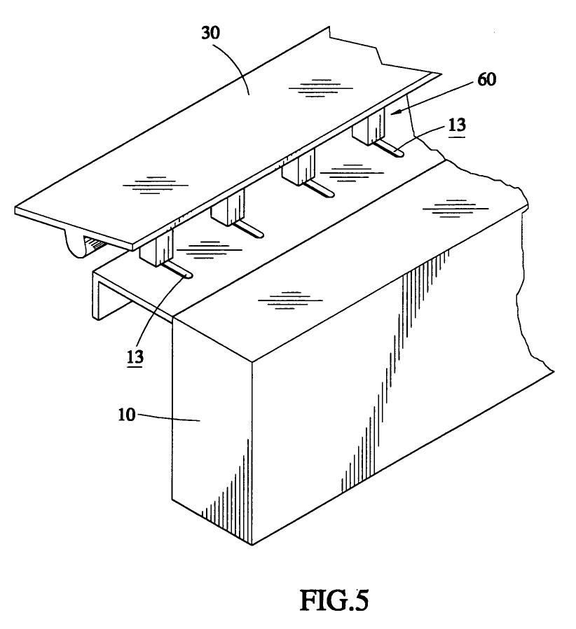

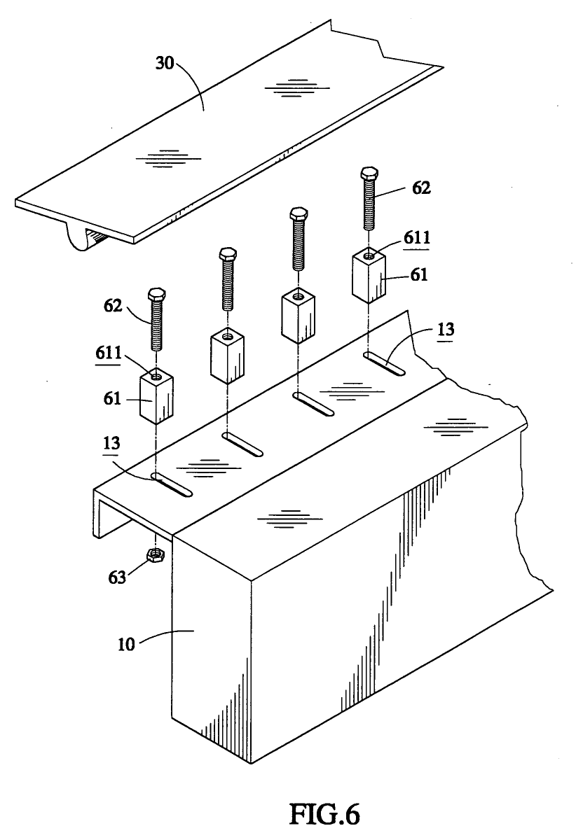

Referring to FIGS. 4-6, a cup rotating device constructed in accordance with another embodiment of the present invention, which is also designated with reference numeral 100 for simplicity, comprises a chassis 10 on which two conveyer belts 30, 40 are movably supported. A driving system comprises a driving device 50 that drives the conveyer belt 40 and a power divider 51 that divides the output power of the driving device 50 for driving the conveyer belt 30. By this way, the conveyer belts 30, 40 are moved in different speeds.

An inclination adjusting device is provided to change and adjust the inclination of each conveyer belt 30, 40. The inclination adjusting device comprises a plurality of adjustors 60, each comprising a block 61 that is interposed between an outer edge of the conveyer belt 30, 40 and the chassis 10 and that is movable in the transverse direction. The block 61 defines a through hole 611 that is internally threaded to engage a bolt 62. A tip end of the bolt 62 extends through the hole 611 and also extends through a transversely extended slot 13 defined in the chassis 10 and engages a nut 63. Thus, the block 61 is retained on the chassis 10 but is allowed to move along the transversely extended slot 13 by loosening the bolt 62 and the nut 63. By moving the block 61 along the transversely extended slot 13, the inclination of the belt 30, 40 is changed and adjusted. The nut 63 also functions to releasably fix the position of the block 61 with respect to the belt 30, 40.

The difference in speed between the conveyer belts 30, 40 causes the cup-shaped containers 200 that are in contact with and conveyed by the belts 30, 40 to rotate about a center axis thereof. This allows a plastic film fit over the cup-shaped container 200 to displace and thus correct relative position thereof with respect to the container 200 and thus realizing snug fitting of the film over the cup-shaped container 200.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A cup rotating device comprising:
a chassis extending in a longitudinal direction;
two conveyer belts supported on the chassis and movable in the longitudinal direction for conveying a cup-shaped container, each conveyer belt having an outer longitudinal edge and an opposite inner edge;
an adjusting mechanism engageable with an underside of the outer edge of each conveyer belt and thus lifting the outer edge with respect to the inner edge to induce an inclination of the conveyer belt whereby the conveyer belt tangentially engaging an outer rim of the cup-shaped container;
a driving system that drives the conveyer belts in different speeds whereby the cup-shaped container is caused to rotate.

2. The cup rotating device as claimed in claim 1, wherein the chassis defines conveyance slots in a central portion thereof.

3. The cup rotating device as claimed in claim 1, wherein the chassis defines a plurality of transversely extended slots.

4. The cup rotating device as claimed in claim 1, wherein the adjusting mechanism comprises an elongate cylindrical rail engaging the outer edge and transversely movably supported by a plurality of adjustors.

5. The cup rotating device as claimed in claim 4, wherein the rail are coupled to coupling bars that are transversely movably supported by the adjustors to selectively move with respect to the conveyer in the transverse direction.

6. The cup rotating device as claimed in claim 4, wherein the adjustor comprises releasable securing means for releasably securing the rail at a selected position.

7. The cup rotating device as claimed in claim 6, wherein the releasable securing means comprises a support in which a transversely-extending through hole is defined to movably receive a coupling bar extending from the rail.

8. The cup rotating device as claimed in claim 7, wherein the releasable securing means comprises a fastener that is threadingly received in an inner-threaded hole defined in the support to releasably secure the coupling bar.

9. The cup rotating device as claimed in claim 1, wherein the adjusting mechanism comprises a block releasably mounted on the chassis by a bolt and nut pair and movable in transverse direction with respect to the belt.

10. The cup rotating device as claimed in claim 9, wherein the block forms a threaded hole with which the bolt engages.

11. The cup rotating device as claimed in claim 1, wherein the driving system comprises a driving device for moving each conveyer belt in the longitudinal direction.

12. The cup rotating device as claimed in claim 1, wherein the driving system comprises a driving device for driving one of the conveyer belts and a power divider that couples the other one of the conveyer belts to the driving device.
